(19) United States
(12) Patent Application Publication
(10) Pub. No.: US 2007/0004445 A1
(43) Pub. Date: Jan. 4, 2007

(54) Apparatus and method for cell selection in a wireless network

(76) Inventors: Donald A. Dorsey, Vernon Hills, IL (US); Steve R. Brandt, Grayslake, IL (US); Sharada Raghuram, Buffalo Grove, IL (US)

Correspondence Address: MOTOROLA INC, 600 NORTH US HIGHWAY 45, ROOM AS437, LIBERTYVILLE, IL, 60048-5343, US

(21) Appl. No.: 11/170,648

(22) Filed: Jun. 29, 2005

(51) Int. Cl. H04Q 7/20

(52) U.S. Cl. 455/525; 455/522

(57) ABSTRACT

An apparatus and method of cell selection in a wireless network for a device operating on a serving cell. A quality threshold is received. A selected radio access technology is prioritized for reselection if at least one radio access technology neighbor cell meets basic criteria for a suitable cell and a computed value of a signal quality suitability criterion of the radio access technology neighbor cell exceeds the quality threshold.

### BACKGROUND

1. Field

The present disclosure is directed to a method and apparatus for cell selection in a wireless network. More particularly, the present disclosure is directed to prioritizing a selected radio access technology for cell reselection.

2. Description of Related Art

Presently, wireless technology continues to advance to offer users of wireless communication devices improved service and better features. For example, newer generation radio access technology (RAT) offer better data rates than older generation RATs. However, newer generation RAT, such as a third generation (3G) RAT may not be available in all areas. Thus, many wireless communication devices can operate on older generation networks, such as second generation (2G) networks, when 3G coverage is unavailable.

Unfortunately, under current signaling schemes, a wireless communication device may drop to a 2G network even though there is good 3G coverage. Then the wireless communication device often shortly reselects back to the 3G network. This creates a problem because the resulting extra registration sequences can cause extra signaling load on the network, can cause extra battery drain, can cause interrupted data transfers, and can cause a poorer call completion rate.

Thus, there is a need for an apparatus and method of cell selection in a wireless network for a device operating on a serving cell where a selected radio access technology is prioritized for reselection.

### SUMMARY

An apparatus and method of cell selection in a wireless network for a device operating on a serving cell. A quality threshold is received. A selected radio access technology is prioritized for reselection if at least one radio access technology neighbor cell meets basic criteria for a suitable cell and a computed value of a signal quality suitability criterion of the radio access technology neighbor cell exceeds the quality threshold.

### BRIEF DESCRIPTION OF THE DRAWINGS

The embodiments of the present disclosure will be described with reference to the following figures, wherein like numerals designate like elements, and wherein:

FIG. 1 is an exemplary block diagram of a system according to one embodiment;

FIG. 2 is an exemplary block diagram of a mobile communication device according to one embodiment;

FIG. 3 is an exemplary flowchart illustrating the operation of a mobile communication device according to one embodiment;

FIG. 4 is an exemplary graph of a serving cell signal quality suitability criterion versus time according to one embodiment.

### DETAILED DESCRIPTION

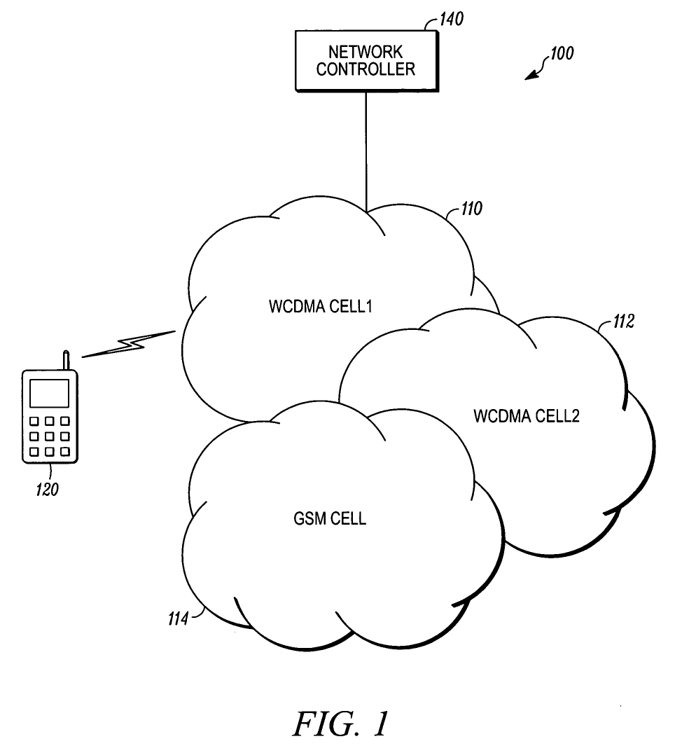

FIG. 1 is an exemplary block diagram of a system 100 according to one embodiment. The system 100 can include a network controller 140, a terminal 120, and network cells 110, 112, and 114. The network cells 110 and 112 may be cells of a first Radio Access Technology (RAT) type and the network cell 114 may be a cell of a second RAT type. For example, the cells 110 and 112 may be third generation (3G) RAT cells such as Wideband Code Division Multiple Access (WCDMA) cells and the cell 114 may be a second generation (2G) RAT cell such as a Global System for Mobile communication (GSM) cell. The terminal 120 may be a mobile communication device, such as a wireless telephone, a cellular telephone, a personal digital assistant, a pager, a personal computer, a selective call receiver, or any other device that is capable of sending and receiving communication signals on a network including wireless network.

In an exemplary embodiment, the network controller 140 can be connected to a network including at least one of the cells. The controller 140 may be located at a base station, at a radio network controller, or anywhere else on the network. The network including the cells may include any type of network that is capable of sending and receiving signals, such as wireless signals. For example, the network may include a wireless telecommunications network, a cellular telephone network, a satellite communications network, and other like communications systems. Furthermore, the network may include more than one network and may include a plurality of different types of networks. Thus, the network may include a plurality of data networks, a plurality of telecommunications networks, a combination of data and telecommunications networks and other like communication systems capable of sending and receiving communication signals.

In operation, the terminal 120 can operate on a serving cell, such as cell 110. The terminal 120 can receive a quality threshold. The terminal 120 can determine if at least one selected RAT neighbor cell, such as cell 112, meets basic criteria for a suitable cell. The terminal 120 can also determine if a computed value of a signal quality suitability criterion of the selected RAT neighbor cell 112 exceeds the quality threshold. The terminal 120 can then prioritize reselection to selected RAT neighbor cells if at least one selected RAT neighbor cell meets basic criteria for a suitable cell and a computed value of a signal quality suitability criterion of the at least one selected RAT neighbor cell exceeds the quality threshold. The quality threshold can be a SsearchRAT measurement rules threshold above which it is not necessary to measure inter-RAT neighbors. Prioritizing can be further based on whether the at least one selected RAT neighbor cell has a measured received signal code power on a common pilot channel that exceeds a minimum threshold. Prioritizing can also include disregarding non-selected RAT neighbor cells, such as cell 114, when performing a reselection ranking operation.

For example, according to a related embodiment, for reselection, if GSM cells are to be measured, the WCDMA serving cell 110 can broadcast information on GSM RAT neighbor cells as well as WCDMA RAT neighbor cells that the terminal 120 is required to measure for reselection purposes. To compare the serving WCDMA cell 110 with WCDMA neighbor cells 112 and GSM neighbor cells 114, the terminal 120 can compute a ranking criteria value, R, for each cell. The terminal 120 then can compare the computed R values for the serving cell 110 and neighbor cells 112 and 114 and attempt to reselect to the cell with the greatest R value. The system 100 can also broadcast a parameter in the system information known as the quality measure for cell selection and reselection. This parameter can indicate whether the measurement quantity to be used when computing the R values for WCDMA cells is the Received Signal Code Power on the Common Pilot Channel (CPICH RSCP) or the signal quality of the Common Pilot Channel (CPICH Ec/Io). Regardless of the value of the quality measure for cell selection and reselection broadcasted by the system 100, the terminal 120 can always use the measurement quantity CPICH RSCP when computing the R values of the WCDMA cells 110 and 112 that will be used in the comparison with GSM cells, such as cell 114. An exemplary algorithm used for computing the R values can operate as follows:

If the quality measure for cell selection and reselection is CPICH RSCP, the terminal 120 can compute the R values for the cells as follows:
For the serving cell: Rs=Qmeas,s+Qhyst,s
For neighbor cells: Rn=Qmeas,n−Qoffsets,n−TOn*(1−Ln)
Where:
Qmeas,s is the measured CPICH RSCP in dBm for the WCDMA serving cell,
Qmeas,n is the measured CPICH RSCP in dBm if the neighbor cell is a WCDMA cell, or the measured Received Signal Strength in dBm if the neighbor cell is a GSM neighbor cell,
Qhyst,s is a parameter in units of dBm broadcasted in the system information that can provide an extra hysteresis for the serving cell,
Qoffsets,n is an offset in units of dBm for the neighbor cell broadcasted in the system information where there is a separate Qoffsets,n broadcasted in system information for each neighbor cell. Usage of Qoffsets,n can enables the system 100 to make it more difficult for the terminal 120 to reselect to some neighbor cells than to others. For example, the greater the value of Qoffsets,n for a neighbor cell, the more that neighbor cell is penalized, and
The term TOn*(1−Ln) can provide an additional temporary offset for a time period known as the penalty time.

After computing all of the R values, the terminal 120 can then begin the attempt to reselect to the best-ranked neighbor cell (WCDMA or GSM) if that neighbor is ranked better than the WCDMA serving cell.

If the quality measure for cell selection and reselection is CPICH Ec/Io, the terminal 120 can perform a first ranking of all of the cells by computing the R values for all of the cells including the serving WCDMA cell 110, neighbor WCDMA cells 112, and neighbor GSM cells 114 as described above. The terminal 120 can then check if a GSM neighbor cell is the best ranked cell among all of the cells, including the serving cell. If it is, the terminal 120 can then begin the process of attempting to reselect to it. If a GSM neighbor cell is not the best ranked cell, the terminal 120 can then perform a second ranking of just the WCDMA serving cell 110 and WCDMA neighbor cells 112. For this second ranking, the computation of the R values can still employ the equations given above. However, the parameters in the equations can be changed as follows:
Qmeas,s is the measured CPICH Ec/Io in dB for the WCDMA serving cell,
Qmeas,n is the measured CPICH Ec/Io in dB for the WCDMA neighbor cell,
Qhyst,s is a parameter in units of dB broadcasted in the system information that provides an extra hysteresis for the serving cell. For this ranking, the terminal 120 can use a separate value of Qhyst,s in units of dB that is intended to be used only for the second ranking,
Qoffsets,n is an offset in units of dB for the neighbor cell broadcasted in the system information. There is a separate Qoffsets,n broadcasted in system information for each neighbor cell. For this ranking, the terminal 120 can use a separate value of Qoffsets,n for each WCDMA neighbor cell in units of dB. This separate value can be used only for the second ranking.

After computing the R values for all the WCDMA cells, the terminal 120 can then begin the attempt to reselect to the best-ranked WCDMA neighbor cell if that neighbor cell is also ranked better than the WCDMA serving cell.

The decision to reselect to a GSM neighbor cell can be based on a comparison of that GSM neighbor cell's Received Signal Strength with the CPICH RSCP of the WCDMA serving and neighbor cells. This comparison may be misguided because:
For WCDMA cells, signal quality (CPCH Ec/Io) can be a much better indication of cell reception “goodness” than is CPICH RSCP.
Values of GSM Received Signal Strength and WCDMA CPICH RSCP that are equal can have much different connotations regarding the cell's goodness. For example a GSM cell whose measured Received Signal Strength is −95 dBm is generally considered to be a cell which is getting weak. But a WCDMA cell whose measured CPICH RSCP is −95 dBm is still considered to be a very good cell if its measured CPICH Ec/Io is high, for example, −5 dB.

The WCDMA serving cell 110 may also optionally broadcast what is known as measurement rules thresholds. These measurement rules thresholds can allow the terminal 120 to avoid performing measurements of certain neighbor cells if the WCDMA serving cell's signal quality (CPICH Ec/Io) is good enough. The thresholds which may be broadcasted can include:
Sintrasearch: If this threshold is broadcast, then the terminal 120 need not measure WCDMA intra-frequency neighbor cells if the serving cell's signal quality suitability criterion, Squal, is above this threshold.
Sintersearch: If this threshold is broadcast, then the terminal 120 need not measure WCDMA inter-frequency neighbor cells if the serving cell's signal quality suitability criterion, Squal, is above this threshold.
SsearchRAT: If this threshold is broadcast, then the terminal 120 UE need not measure GSM neighbor cells if the serving cell's signal quality suitability criterion, Squal, is above this threshold.

To use these thresholds, the terminal 120 can first compute the WCDMA serving cell's signal quality suitability criterion, Squal, using the following formula:
Squal=Qqualmeas−Qqualmin

Where Qqualmeas is the measured CPICH Ec/Io of the serving cell and Qqualmin is a parameter broadcast in the system information which represents the minimum cell quality for the cell to be considered suitable for camping. The terminal 120 can then compare the computed Squal with each measurement rules threshold. If the computed value of Squal is greater than the threshold, then the terminal 120 need not perform measurements on the associated neighbor cells.

Although the original intent of these measurement rules thresholds was to allow the terminal 120 to save on battery consumption by not performing measurements when they are not really needed, the SsearchRAT threshold can be used by network operators having cells of both RATs as a criteria for 3G to 2G inter-RAT reselection. In particular, it can be used as a way to insure that the terminal 120 will never reselect from WCDMA to GSM unless the WCDMA cell's signal quality is becoming very poor. Some reasons for this usage can include:
Operators having cells of both RATs almost always want the terminal 120 to remain on a WCDMA RAT, and not go to GSM RAT, unless the coverage becomes very poor. For example, they want to make sure that their subscribers who have paid for 3G services are able to remain on 3G and take advantage of any services offered only in 3G whenever possible.
As stated above, the comparison of GSM Received Signal Strength with WCDMA CPICH RSCP may be a misguided comparison. Thus, usage of SsearchRAT can allow an operator to avoid this issue altogether. In particular, the operator can avoid having the UE perform this comparison and possibly reselect to a GSM cell as long as the WCDMA cell's signal quality suitability criterion remains greater than or equal to the broadcasted SsearchRAT threshold.

If the operator also broadcasts the measurement rules thresholds Sintrasearch and Sintersearch in addition to SsearchRAT, then Sintrasearch and Sintersearch are usually set much higher than SsearchRAT. The intent of this is that as the serving cell's signal quality starts to go down, the terminal 120 can first begin measuring WCDMA neighbor cells and possibly reselect to a WCDMA neighbor cell before the point at which it even begins to measure GSM cells and consider them as candidates for reselection. The reason for this is that, as stated above, operators having cells of both RATs almost always want the terminal 120 to remain on WCDMA RAT and not go to GSM RAT unless the coverage becomes very poor.

In addition to performing measurements on neighbor cells and computing the R (ranking) values, the terminal 120 can always compute the suitability criteria for the serving cell 110. For example, it can compute Squal and also Srxlev which is defined as follows:
Srxlev=Qrxlevmeas−Qrxlevmin−Pcompensation

Where Qrxlevmeas is the measured CPICH RSCP on the WCDMA serving cell 110, Qrxlevmin is a parameter broadcasted in the system information which represents the minimum CPICH RSCP for the cell to be considered suitable for camping and Pcompensation is a penalty amount which is subtracted in the case that the terminal's actual transmit power capability is less than the maximum transmit power which the network allows the terminal 120 to use when sending Random Access Bursts. If the terminal 120 finds that either Squal<=0 or Srxlev<=0, it can then enter a state in which it is allowed to reselect to any suitable cell.

The 2G to 3G reselection algorithm can include a comparison of the Received Signal Strength measured on GSM serving and neighbor cells with the CPICH RSCP measured on the WCDMA neighbor cells. However, whether this comparison is actually performed is controlled by the parameter FDD_Qoffset broadcasted in the system information on the GSM serving cell. For example, if the parameter FDD_Qoffset is set to the value 0, this means that the terminal 120 need not perform the RSSI/RSCP comparison and it can simply attempt reselection to the WCDMA neighbor cell 110 or 112 as long as it meets the following criteria:

The 2G to 3G reselection algorithm defines the following two thresholds which must be met in order for the terminal 120 to attempt reselection to a WCDMA neighbor cell 110 or 112:
FDD_Qmin: This parameter can be broadcast in the system information on a GSM serving cell. It can define the minimum value of the measured CPICH Ec/Io of a WCDMA neighbor cell 110 or 112 in order for the terminal 120 to be allowed to reselect to a WCDMA neighbor cell 110 or 112.
FDD_RSCPmin; This parameter can also be broadcast in the system information on the GSM serving cell. It can define the minimum value of the measured CPICH RSCP of a WCDMA neighbor cell in order for the UE to be allowed to reselect to a WCDMA neighbor cell 110 or 112.

One problem that can occur is that in a configuration in which the network is broadcasting the SsearchRAT measurement rules threshold and in which a network operator intends this to be used as a criteria for 3G to 2G inter-RAT reselection, it is possible for a terminal 120 to reselect from a WCDMA cell 110 to a GSM cell 114 even in an area where there are other very good WCDMA neighbor cells 112 present, for example, cells which have a signal quality suitability criterion, Squal, that already exceeds the SsearchRAT threshold. For example consider the following scenario:

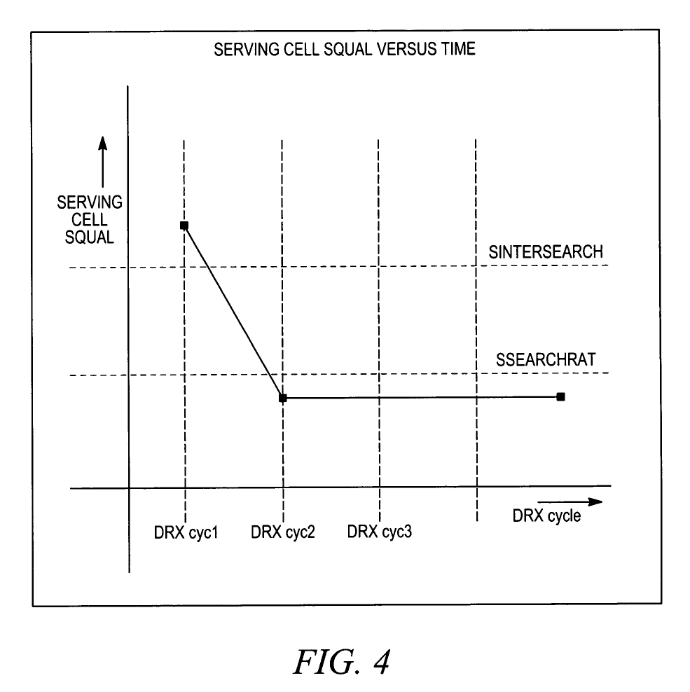

The terminal 120 is camped on a WCDMA cell 110 in an area where there are WCDMA inter-frequency neighbor cells 112 and also GSM neighbor cells 114. The system 110 broadcasts both the Sintersearch and SsearchRAT measurement rules thresholds and has Sintersearch set much higher than SsearchRAT. For example, assume Sintersearch is set 6 dB higher than SsearchRAT. Initially, the signal quality on the serving cell is such that the serving cell's Squal exceeds both Sintersearch and SsearchRAT. Thus, the terminal 120 is initially measuring neither inter-frequency neighbors nor GSM neighbors. The terminal 120 may then move in such a way that the signal quality on the serving cell drops very quickly. In particular, the signal quality can quickly drop below both the Sintersearch and SsearchRAT thresholds. A plot of the serving cell's signal quality versus time is illustrated in FIG. 4. As illustrated, in the time period of only one DRX cycle, for example, from DRX cyc1 to DRX cyc2, the serving cell's Squal has dropped below both the Sintersearch and SsearchRAT thresholds. Where the DRX cycle can specify how often to for the terminal 120 should wake up from sleep cycles to receive paging indicators.

After the drop in the serving cell's Squal occurs, the terminal 120 may be in an area where the WCDMA inter-frequency neighbor cells 112 have good signal quality, i.e. these cells have an Squal>SsearchRAT. However, these cells may have a CPICH RSCP which is less than the Received Signal Strength of the GSM neighbor cells 114. For example, the CPICH RSCP may be −85 dBm whereas the Received Signal Strength of the GSM cells may be −80 dBm. Thus, after the drop in the serving cell's Squal, the terminal 120 will begin measurements on the WCDMA inter-frequency neighbor cells 112 and the GSM neighbor cells 114 at roughly the same time, and the first ranking which it performs will likely include both types of cells. During the first ranking, the terminal 120 can compare the R values of the GSM cells (RSSI of −80 dBm) with the R values of the WCDMA inter-frequency cells (CPICH RSCP of −85 dBm), determine that the GSM cell 114 is ranked better, and reselect to the GSM cell 114. After the terminal 120 camps on the GSM cell, it may be likely to later reselect back to a WCDMA neighbor cell 112 because the terminal 120 may find that one of the original WCDMA inter-frequency neighbors that it failed to reselect to before meets the 2G to 3G reselection threshold FDD_Qmin, i.e. it has a CPICH Ec/Io>FDD_Qmin.

This behavior may be a problem because it has the following undesirable effects:
It can cause extra registration sequences. For example, most network operators separate their 2G cells and 3G cells under different location areas and routing areas. Therefore, each time the terminal 120 changes RATs, for example, from 3G to 2G or from 2G back to 3G, it may have to perform both a Location Update and a Routing Area Update. This double registration sequence can drain the battery and cause extra signalling load on the network.
If the terminal 120 is involved in a data transfer at the time, the data transfer may be interrupted due to the registration sequences which must be performed, and the transfer may be aborted entirely because the delay due to the double registration sequence is so long that the higher layer protocol used for the transfer, such as FTP, times out.
It can result in poorer Mobile-Terminated (MT) call performance due to the terminal's missed pages. For example, as stated above, most network operators separate their 2G cells and 3G cells under different location areas. Therefore, from the instant the terminal 120 reselects to a different RAT to the instant it completes its Location Update on that RAT, it will be unreachable for MT calls because the network will not be paging the UE in the new location area yet.

To avoid these possible problems, in the case in which the network broadcasts the SsearchRAT measurement rules threshold, the terminal 120 can be allowed to prioritize reselection to WCDMA neighbor cells. For example, the terminal 120 can be allowed to disregard GSM neighbor cells when performing the reselection ranking operation and comparison of cells, and consider only WCDMA neighbor cells as candidates for reselection. The terminal can prioritize reselection if it determines that there is at least one WCDMA neighbor cell present which meets these criteria:
It meets the basic criteria for a suitable cell. For example, for this WCDMA neighbor cell:
   Squal>0 and Srxlev>0,
The computed value of its signal quality suitability criterion, Squal, exceeds the broadcasted SsearchRAT threshold. In other words:
   Squal>SsearchRAT, and
Its measured CPICH RSCP exceeds a minimum CPICH RSCP threshold.

The third check above (i.e. the CPICH RSCP threshold check) may be performed is to insure that the CPICH RSCP is not extremely low. If such were the case, then the terminal 120 might actually be on the very edge of the WCDMA coverage area and it might actually be better off to go to GSM RAT in that case. This minimum threshold can be set to some value that is below −80 dBm, −90 dBm, −100 dBm, −110 dBm, or the like. Possible values that can be used include:
The default value of the FDD_RSCPmin threshold used in 2G to 3G cell reselection. For example, values ranging from −109 dBm to −101 dBm.
Qrxlevmin+Pcompensation+10 dB. For example, the sum of the Qrxlevmin broadcasted by the WCDMA serving cell 110, and the Pcompensation penalty amount, which can be applied when determining suitability if the terminal 120's actual transmit power capability is less than the maximum transmit power which the network allows, and a constant hysteresis value of about 10 dB. This threshold check can make it unlikely that the terminal 120 would find this WCDMA cell to be unsuitable shortly after reselecting to it since the measured CPICH RSCP is unlikely to change by a full 10 dB in such a short time.

Thus, undesirable drops to 2G in areas having good 3G coverage can be avoided and problems associated with the undesirable drops can be avoided. For example, this prioritization of 3G cells be performed by the terminal 120 both when Squal<SsearchRAT and the serving cell is still suitable and also when the serving cell has become unsuitable.

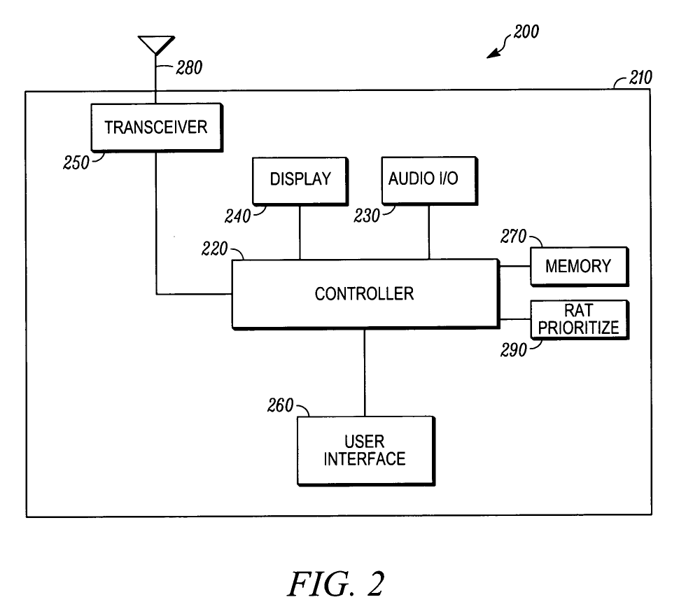

FIG. 2 is an exemplary block diagram of a mobile communication device 200, such as the terminal 120, according to one embodiment. The mobile communication device 200 can include a housing 210, a controller 220 coupled to the housing 210, audio input and output circuitry 230 coupled to the housing 210, a display 240 coupled to the housing 210, a transceiver 250 coupled to the housing 210, a user interface 260 coupled to the housing 210, a memory 270 coupled to the housing 210, and an antenna 280 coupled to the housing 210 and the transceiver 250. The mobile communication device 200 can also include a RAT prioritize module 290. The RAT prioritize module 290 can be coupled to the controller 220, can reside within the controller 220, can reside within the memory 270, can be autonomous modules, can be software, can be hardware, or can be in any other format useful for a module on a mobile communication device 200.

The display 240 can be a liquid crystal display (LCD), a light emitting diode (LED) display, a plasma display, or any other means for displaying information. The transceiver 250 may include a transmitter and/or a receiver. The audio input and output circuitry 230 can include a microphone, a speaker, a transducer, or any other audio input and output circuitry. The user interface 260 can include a keypad, buttons, a touch pad, a joystick, an additional display, or any other device useful for providing an interface between a user and a electronic device. The memory 270 may include a random access memory, a read only memory, an optical memory, a subscriber identity module memory, or any other memory that can be coupled to a mobile communication device.

In operation, the transceiver 250 can be configured to transmit and receive signals on a serving cell in a wireless network where the received signals include a measurement rules threshold. The controller 220 can be configured to perform cell selection in the wireless network, such as the system 100. The RAT prioritize module 290 can be configured to prioritize reselection to WCDMA neighbor cells if at least one WCDMA cell meets basic criteria for a suitable cell and a computed value of a signal quality suitability criterion of the at least one WCDMA neighbor cell exceeds the measurement rules threshold. The measurement rules threshold can be a SsearchRAT measurement rules threshold.

The controller 220 can be further configured to compare the signal quality suitability criterion of the serving cell to the SsearchRAT measurement rules threshold to determine if the device 200 should take measurements of GSM neighbor cells. The basic criteria for a suitable cell can be based on the computed value of a signal quality suitability criterion of the WCDMA cell being greater than zero and a measured received signal code power on a common pilot channel of the WCDMA cell minus a parameter broadcast in system information minus a penalty amount being greater than zero. The parameter broadcast in system information can represent a minimum received signal code power on a common pilot channel for a cell to be considered suitable for camping. The penalty amount can account for an actual transmit power capability of the device 200 being less than a maximum transmit power that the wireless network allows the device 200 to use when sending random access bursts. Prioritizing can be further based on whether the at least one WCDMA neighbor cell has a measured received signal code power on a common pilot channel that exceeds a minimum threshold. Prioritizing can also comprise disregarding GSM neighbor cells when performing a reselection ranking operation.

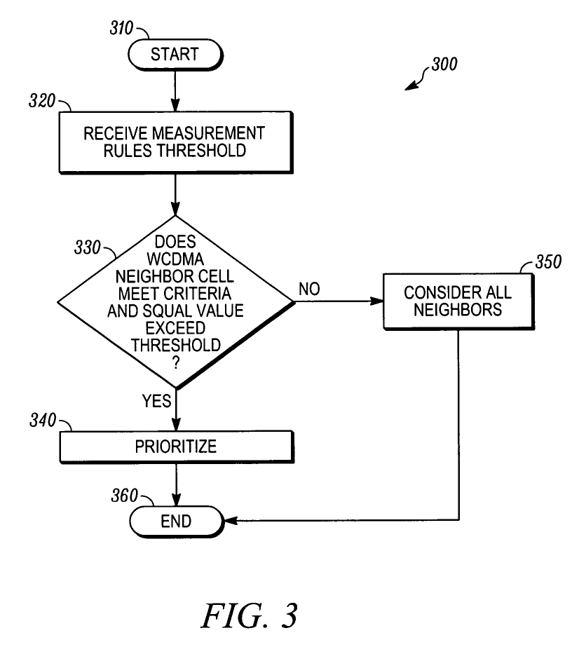

FIG. 3 is an exemplary flowchart 300 illustrating the operation of the mobile communication device 200 according to another embodiment. In step 310, the flowchart begins. In step 320, the device 200 can receive a quality threshold. The quality threshold can be a measurement rules threshold such as SsearchRAT measurement rules threshold. In step 330, the device 200 can determine if a WCDMA neighbor cell meets basic criteria for a suitable cell and if a computed value of a signal quality suitability criterion of the WCDMA neighbor cell exceeds the measurement rules threshold. The device 200 may also compare the signal quality suitability criterion of the serving cell to the SsearchRAT measurement rules threshold to determine whether the device 200 should take measurements of GSM neighbor cells. If the answer to step 330 is “no,” in step 350, the device 200 can consider all neighbors. If the answer to step 330 is “yes,” in step 340, the device 200 can prioritize reselection to WCDMA neighbor cells. Prioritizing may be based on whether the at least one WCDMA neighbor cell has a measured received signal code power on a common pilot channel that exceeds a minimum threshold. Prioritizing may also entail disregarding GSM neighbor cells when performing a reselection ranking operation.

The basic criteria for a suitable cell can be based on the computed value of a signal quality suitability criterion of the WCDMA cell being greater than zero and a measured received signal code power on a common pilot channel of the WCDMA cell minus a parameter broadcast in system information minus a penalty amount being greater than zero. The parameter broadcast in system information can represent a minimum received signal code power on a common pilot channel for a cell to be considered suitable for camping. The penalty amount can account for an actual transmit power capability of the device 200 being less than a maximum transmit power that the wireless network allows the device 200 to use when sending random access bursts. In step 360, the flowchart 300 ends.

The method of this disclosure is preferably implemented on a programmed processor. However, the controllers, flowcharts, and modules may also be implemented on a general purpose or special purpose computer, a programmed microprocessor or microcontroller and peripheral integrated circuit elements, an ASIC or other integrated circuit, a hardware electronic or logic circuit such as a discrete element circuit, a programmable logic device such as a PLD, PLA, FPGA or PAL, or the like. In general, any device on which resides a finite state machine capable of implementing the flowcharts shown in the Figures may be used to implement the processor functions of this disclosure.

While this disclosure has been described with specific embodiments thereof, it is evident that many alternatives, modifications, and variations will be apparent to those skilled in the art. For example, various components of the embodiments may be interchanged, added, or substituted in the other embodiments. Also, all of the elements of each figure are not necessary for operation of the disclosed embodiments. For example, one of ordinary skill in the art of the disclosed embodiments would be enabled to make and use the teachings of the disclosure by simply employing the elements of the independent claims. Accordingly, the preferred embodiments of the disclosure as set forth herein are intended to be illustrative, not limiting. Various changes may be made without departing from the spirit and scope of the disclosure.

What is claimed is:

1. A method of cell selection in a wireless network for a device operating on a serving cell comprising:
receiving a threshold;
prioritizing reselection to wideband code division multiple access neighbor cells if:
at least one wideband code division multiple access neighbor cell meets basic criteria for a suitable cell, and
a computed value of a signal quality suitability criterion of the at least one wideband code division multiple access neighbor cell exceeds the threshold.

2. The method according to claim 1, wherein the threshold is a SsearchRAT measurement rules threshold.

3. The method according to claim 2, further comprising comparing the signal quality suitability criterion of the serving cell to the SsearchRAT measurement rules threshold to determine if the device should take measurements of global system for mobile communications neighbor cells.

4. The method according to claim 1, wherein the basic criteria for a suitable cell is based on:
the computed value of a signal quality suitability criterion of the wideband code division multiple access cell being greater than zero, and
a measured received signal code power on a common pilot channel of the wideband code division multiple access cell minus a parameter broadcast in system information minus a penalty amount being greater than zero.

5. The method according to claim 4, wherein the parameter broadcast in system information represents a minimum received signal code power on a common pilot channel for a cell to be considered suitable for camping.

6. The method according to claim 4, wherein the penalty amount accounts for an actual transmit power capability of the device being less than a maximum transmit power that the wireless network allows the device to use when sending random access bursts.

7. The method according to claim 1, wherein prioritizing is further based on whether the at least one wideband code division multiple access neighbor cell has a measured received signal code power on a common pilot channel that exceeds a minimum threshold.

8. The method according to claim 1, wherein prioritizing comprises disregarding global system for mobile communication neighbor cells when performing a reselection ranking operation.

9. A mobile communication device comprising:
a transceiver configure to transmit and receive signals on a serving cell in a wireless network where the received signals include a threshold;
a controller coupled to the transceiver, the controller configured to perform cell selection in the wireless network; and
a radio access technology prioritize module configured to prioritize reselection to wideband code division multiple access neighbor cells if at least one wideband code division multiple access neighbor cell meets basic criteria for a suitable cell and a computed value of a signal quality suitability criterion of the at least one wideband code division multiple access neighbor cell exceeds the threshold.

10. The mobile communication device according to claim 9, wherein the threshold is a SsearchRAT measurement rules threshold.

11. The mobile communication device according to claim 10, wherein the controller is further configured to compare the signal quality suitability criterion of the serving cell to the SsearchRAT measurement rules threshold to determine if the device should take measurements of global system for mobile communications neighbor cells.

12. The mobile communication device according to claim 9, wherein the basic criteria for a suitable cell is based on:
the computed value of a signal quality suitability criterion of the wideband code division multiple access cell being greater than zero, and
a measured received signal code power on a common pilot channel of the wideband code division multiple access cell minus a parameter broadcast in system information minus a penalty amount being greater than zero.

13. The mobile communication device according to claim 12, wherein the parameter broadcast in system information represents a minimum received signal code power on a common pilot channel for a cell to be considered suitable for camping.

14. The mobile communication device according to claim 12, wherein the penalty amount accounts for an actual transmit power capability of the device being less than a maximum transmit power that the wireless network allows the device to use when sending random access bursts.

15. The mobile communication device according to claim 9, wherein prioritizing is further based on whether the at least one wideband code division multiple access neighbor cell has a measured received signal code power on a common pilot channel that exceeds a minimum threshold.

16. The mobile communication device according to claim 9, wherein prioritizing comprises disregarding global system for mobile communication neighbor cells when performing a reselection ranking operation.

17. A method of cell selection in a wireless network for a device operating on a serving cell comprising:
receiving a quality threshold;
determining if at least one selected radio access technology neighbor cell meets basic criteria for a suitable cell;
determining if a computed value of a signal quality suitability criterion of the selected radio access technology neighbor cell exceeds the quality threshold; and
prioritizing reselection to selected radio access technology neighbor cells if:
at least one selected radio access technology neighbor cell meets basic criteria for a suitable cell, and
a computed value of a signal quality suitability criterion of the at least one selected radio access technology neighbor cell exceeds the quality threshold.

18. The method according to claim 17, wherein the quality threshold is a SsearchRAT measurement rules threshold above which it is not necessary to measure inter-radio access technology neighbors.

19. The method according to claim 17, wherein prioritizing is further based on whether the at least one selected radio access technology neighbor cell has a measured received signal code power on a common pilot channel that exceeds a minimum threshold.

20. The method according to claim 17, wherein prioritizing comprises disregarding non-selected radio access technology neighbor cells when performing a reselection ranking operation.
